(19) United States
(12) Patent Application Publication
(10) Pub. No.: US 2008/0318019 A1
(43) Pub. Date: Dec. 25, 2008

(54) SLIP SHEET FOR CONSTRUCTION

(76) Inventor: Michael E. Walda, Harbor Springs, MI (US)

Correspondence Address: REISING, ETHINGTON, BARNES, KISSELLE, P.C., P O BOX 4390, TROY, MI, 48099-4390, US

(21) Appl. No.: 12/201,723

(22) Filed: Aug. 29, 2008

Related U.S. Application Data
(63) Continuation-in-part of application No. 11/482,597, filed on Jul. 7, 2006.

(51) Int. Cl. E04F 13/00; B32B 7/00; B32B 37/00

(52) U.S. Cl. 428/220; 156/71

(57) ABSTRACT

A slip sheet provides a vapor barrier at a location where two siding boards abut after being secured to a wall. This slip sheet includes moisture impervious material having a predetermined thickness. The sheet of impervious material allows the slip sheet to slide between one of the siding boards and the wall. The slip sheet also includes a strip of adhesive that extends only along a top edge of the sheet of moisture impervious material to temporarily secure the sheet of moisture impervious material to the wall until each of the siding boards is secured thereto.

This patent application is a continuation-in-part of a U.S. patent application having Ser. No. 11/482,597, filed Jul. 7, 2006, and claims priority thereto.

### BACKGROUND ART

1. Field of the Invention

The invention relates to creating vapor barriers behind siding boards of a building. More particularly, the invention relates to a device to prevent water and water vapor from seeping between the ends of siding boards that abut each other.

2. Description of the Related Art

When siding board is secured to a wall of a building, it is necessary at times to reinforce a vapor barrier at the joints where siding boards meet. Such protection further facilitates the function of the siding boards to shed water.

Typically, a hard material is inserted behind the siding board and secured to the wall at locations where siding boards abut. The use of these hard materials is cumbersome and time consuming. The time consumption is involved in affixing the hard material to the wall at a proper location and at a proper height. The added thickness created by the application of these hard materials to the wall also must be taken into account.

### SUMMARY OF THE INVENTION

A slip sheet provides a vapor barrier at a location where two siding boards abut after being secured to a wall. This slip sheet includes moisture impervious material having a predetermined thickness. The sheet of impervious material allows the slip sheet to slide between one of the siding boards and the wall. The slip sheet also includes a strip of adhesive that extends along a portion of the sheet of moisture impervious material to temporarily secure the sheet of moisture impervious material to the wall until each of the siding boards is secured thereto.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a building, partially cutaway, showing the use of one embodiment of the invention; and

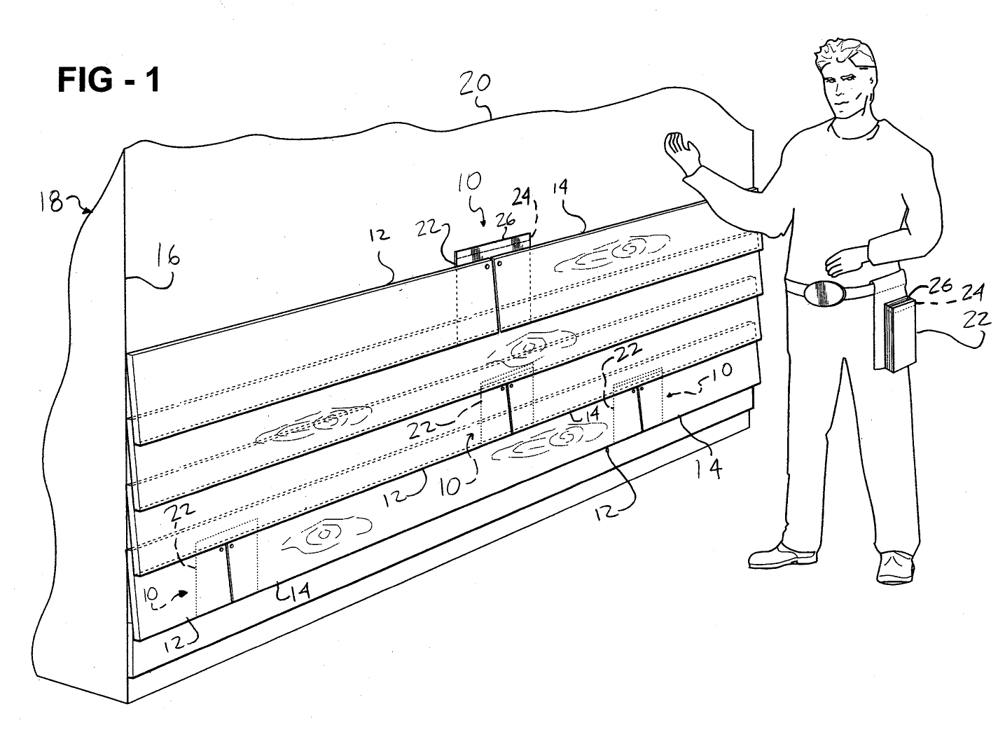

FIG. 2 is a front view of the invention secured to a wall behind siding boards.

### DESCRIPTION OF THE PREFERRED EMBODIMENT

Referring to the Figures, the invention, a slip sheet, is generally indicated at 10. The slip sheet 10 provides a vapor barrier at a location where two siding boards 12, 14 abut. Although not shown, the slip sheet 10 may be used at a location where two siding boards 12, 14 meet at a corner 16 of a building, generally shown at 18. In the Figures, the slip sheets 10 are, however, shown to be secured to a wall 20 against which the two siding board 12, 14 are secured.

The slip sheet 10 includes a sheet of moisture impervious material 22. In the embodiment shown, the sheet of moisture impervious material is shaped in a rectangle. It should be appreciated by those skilled in the art that the sheets 22 maybe cut in any shape desired for a particular wall 20 or siding board 14 configuration. The sheets 22 have a predetermined thickness. This thickness is approximately three mils. In one embodiment, the thickness is approximately 4.5 mils. Therefore, the sheets 22 are thin enough such that they will be able to be slid behind siding boards 14 before or after the siding boards 12, 14 are secured to the wall 20. In the preferred embodiment, the sheets of moisture impervious material 22 are fabricated from polypropylene copolymer black surface and a gray corona treated EVA copolymer surface. Other materials that may be used include, but are not limited to, polyethylene or other synthetic plastic materials having a thickness four mils or less. The sheets 22 may be fabricated out of this material, sold by Raven Industries, Sioux Falls, S. Dak., under the trademark Raven F450BD.

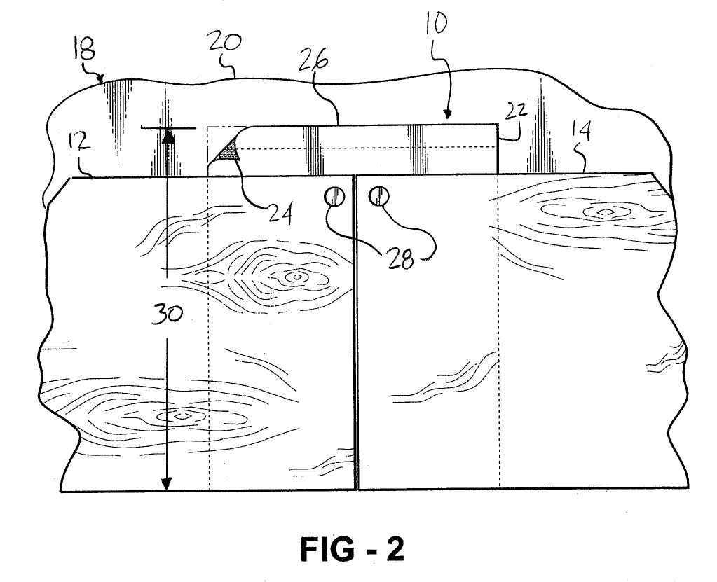

The slip sheet 10 also includes a strip of adhesive 24 (best shown in FIG. 2 with a corner of the sheet 22 pulled back). The strip of adhesive 24 extends along a portion of this sheet of moisture impervious material 22 to temporarily secure the sheet of moisture impervious material 22 to the wall 20 until each of the siding boards 12, 14 is secured thereto. In the preferred embodiment as shown in the Figures, the strip of adhesive 24 extends along a top edge 26 of the sheet of moisture impervious material 22. Because the strip of adhesive 24 extends along a portion of the sheet of impervious material 22, it extends only along the top edge 26. The strip of adhesive 24 is approximately one inch wide and extends across the entire top edge 26 of the sheet 22. The strip of the adhesive 24 is strong enough to hold the sheet 22 against the wall 20 during the finishing of the wall 20. Once the siding boards 12, 14 are secured to the wall 20 using fasteners 28, it is the fasteners 28 that continue to hold the sheet of moisture impervious material 22 in place against the wall 20 over the duration of the life of the siding boards 12, 14.

The slip sheet 10 defines a length 30 which is great that the width of the siding boards 12, 14. In operation, the slip sheet 10 is used to prevent water from reaching the wall 20 covered by the siding boards 12, 14. A method for using the slip sheet 10 includes the positioning of a first siding board 12 on the wall 20. The slip sheet 10 is then slid between the siding board 12 and the wall 20. The slip sheet 10 is then adhered to the wall 20 by pressing the strip of adhesive 24 thereagainst. A second siding board 14 is then positioned with respect to the wall 20 and the first siding board 12 such that they abut one another. Then, the siding boards 12, 14 are secured to the wall 20 using fasteners 28. The fasteners 28 are also used to secure the slip sheet 10 thereto by positioning the fasteners 28 at a location where the siding boards 12, 14 overlap the slip sheet 10. If necessary, the slip sheet 10 is then cut so that any portion thereof that would hang over the bottom of the siding boards 12, 14 is exposed would be removed.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A slip sheet for providing a vapor barrier at a location where two siding boards abut after being secured to a wall, said slip sheet comprising:
a sheet of moisture impervious material having a predetermined thickness allowing said slip sheet to slide between one of the siding boards and the wall, said sheet of moisture impervious material defining a top edge; and
a strip of adhesive extending only along said top edge of said sheet of moisture impervious material to temporarily secure said sheet of moisture impervious material to the wall until each of the siding boards is secured thereto.

2. A slip sheet as set forth in claim 1 wherein said sheet of moisture impervious material defines a length greater than a width of the siding boards.

3. A slip sheet as set forth in claim 2 wherein said sheet of moisture impervious material is fabricated from polypropylene.

4. A slip sheet as set forth in claim 3 wherein said sheet of moisture impervious material defines a thickness of 4.5 mils or less.

5. A method for preventing water from reaching a wall covered by siding boards using a plurality of slip sheets, the method including the steps of:
positioning a first siding board on the wall;
sliding a slip sheet between the siding board and the wall;
adhering the slip sheet to the wall;
positioning a second siding board on the wall in abutting relationship with the first siding board; and
securing the siding boards to the wall.

6. A method as set forth in claim 4 including the step of cutting the slip sheet such that the slip sheet extends to a bottom edge of each of the siding boards.

7. A method as set forth in claim 5 wherein the step of adhering the slip sheet to the wall includes the step of adhering only a top edge of the slip sheet to the wall.
